(19) United States
(12) Patent Application Publication
(10) Pub. No.: US 2022/0404841 A1
(43) Pub. Date: Dec. 22, 2022

(54) INFORMATION PROCESSING SYSTEM, INFORMATION PROCESSING METHOD, AND INFORMATION PROCESSING PROGRAM

(71) Applicant: SONY GROUP CORPORATION, Tokyo (JP)

(72) Inventor: Tatsuya ISHIZUKA, Tokyo (JP)

(73) Assignee: SONY GROUP CORPORATION, Tokyo (JP)

(21) Appl. No.: 17/640,628

(22) PCT Filed: Jul. 15, 2020
(86) PCT No.: PCT/JP2020/027458

§ 371 Date: Mar. 4, 2022

(30) Foreign Application Priority Data
Sep. 25, 2019 (JP) 2019-173890

(51) Int. Cl. G05D 1/10; G05D 1/00; B64C 39/02

(52) U.S. Cl. CPC G05D 1/101; G05D 1/0016; B64C 39/024; B64C 2201/146; B64C 2201/127

(57) ABSTRACT

An information processing system includes: an information processing device configured to control a speed of a moving object that autonomously moves along a preset trajectory; and an input device including an input unit that receives an input from a user and configured to supply an input value input from the user and used to control the speed of the moving object to the information processing device.

### TECHNICAL FIELD

The present invention relates to an information processing system, an information processing method, and an information processing program.

### BACKGROUND ART

Moving objects such as wheelchairs have been widespread since the past. Further, various semi-moving objects and moving objects such as drones and robots have recently begun to become widespread.

There are various methods of manipulating such moving objects. As one such method, a technology for manipulating a semi-autonomous moving robot such as a wheelchair that includes a manipulation lever for inputting a manipulation amount and a trajectory advancing and retreating button formed by an advancing button and a retreating button has been proposed (see PTL 1).

### CITATION LIST

### Patent Literature

### [PTL 1]

JP 2011-212092 A

### SUMMARY

### Technical Problem

In recent years, it has become necessary for a single user to mount a device different from a moving object or a semi-moving object (hereinafter collectively referred to as a moving object), for example, a camera or the like, and perform both a manipulation of a moving object and a manipulation of the other device in some cases. For such cases, a simpler method of manipulating a moving object is required. In the technology disclosed in PTL 1, there are two different operators such as a lever and a button. Therefore, it is difficult to manipulate the moving object while manipulating the other device.

The present technology has been devised in view of such circumstances and an objective of the present technology is to provide an information processing system, an information processing method, and an information processing program capable of easily performing speed control of a moving object.

### Solution to Problem

To solve the above-described problem, a first technology is an information processing system that includes: an information processing device configured to control a speed of a moving object that autonomously moves along a preset trajectory; and an input device including an input unit that receives an input from a user and is configured to supply an input value input by the user and used to control the speed of the moving object to the information processing device.

A second technology is an information processing method that includes controlling a speed of a moving object that autonomously moves along a preset trajectory based on an input value input by a user to an input device including an input unit that receives the input from the user.

A third technology is an information processing program causing a computer to perform an information processing method of controlling a speed of a moving object that autonomously moves along a preset trajectory based on an input value input by a user to an input device including an input unit that receives the input from the user.

### BRIEF DESCRIPTION OF DRAWINGS

FIG. 1 is a diagram illustrating an overall configuration according to an embodiment of the present technology.

FIG. 2 is an external view illustrating a configuration of a moving object 100.

FIG. 3 is a block diagram illustrating a configuration of a moving object 100.

FIG. 4A is an external view illustrating a first example of an input device 200 and FIG. 4B is a block diagram illustrating the input device 200.

FIG. 5 is a diagram illustrating a first exemplary input method for the input device 200.

FIG. 6 is a graph illustrating a relation between an input value and an output value.

FIG. 7 is an external view illustrating a second example of the input device 200.

FIG. 8 is a partially expanded view of the second example of the input device 200.

FIG. 9 is an external view illustrating a modified example of the second example of the input device 200.

FIG. 10 is a diagram illustrating a precedent trajectory.

FIG. 11 is a block diagram illustrating a configuration of an information processing device 300.

FIG. 12 is a diagram illustrating a process of extracting a target position/time from the precedent trajectory.

FIG. 13 is a block diagram illustrating a configuration of an imaging device 400.

### DESCRIPTION OF EMBODIMENTS

Hereinafter, embodiments of the present technology will be described with reference to the drawings. The description will be made in the following order.

### <1. Embodiment>

### [1-1. Overall Configuration]

### [1-2. Configuration of Moving Object 100]

### [1-3. Configuration of Input Device 200]

### [1-3-1. First Exemplary Configuration of Input Device 200]

### [1-3-2. Second Exemplary Configuration of Input Device 200]

### [1-4. Configuration and Speed Control Process of Information Processing Device]

### [1-4-1. Precedent Trajectory]

### [1-4-2. Configuration and Process of Information Processing Device 300]

### [1-5. Configuration of Imaging Device 400]

### <2. Modified Examples>

### 1. Embodiment

### [1-1. Overall Configuration]

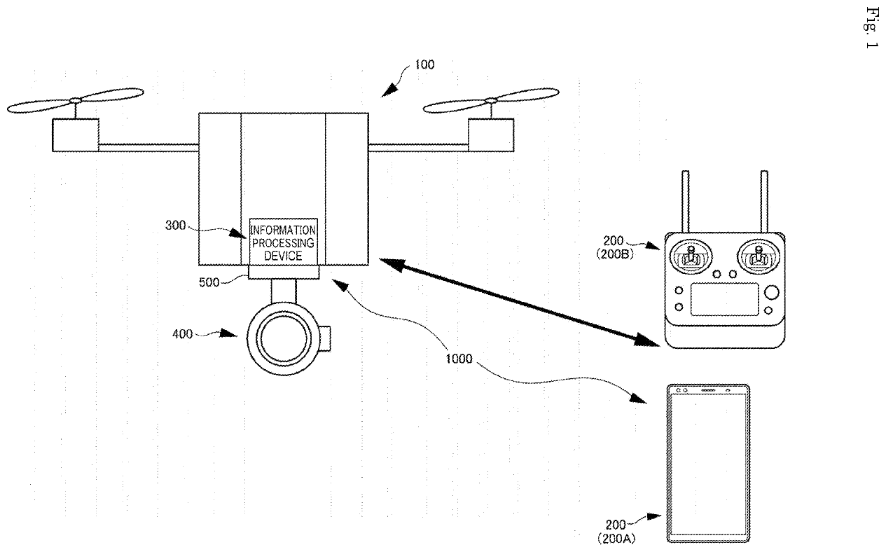

First, an overall configuration according to an embodiment of the present technology will be described with reference to FIG. 1. In the embodiment, a moving object 100, an information processing system 1000 that includes an input device 200 and an information processing device 300 and controls an operation of the moving object 100, and an imaging device 400 that is mounted on the moving object 100 and performs imaging are included.

In the embodiment, the moving object 100 is a small electric flying body (an unmanned aircraft) called a drone.

The input device 200 is a controller used by a user on the ground and transmits information to perform speed control to the information processing device 300 based on input content from the user. As will be described in detail below, as the input device 200 according to the embodiment, there are an input device 200A which is a type of terminal apparatus and an input device 200B that is a type of dedicated controller.

The information processing device 300 operates in the moving object 100 and performs speed control of the moving object 100 in accordance with an instruction from the input device 200.

The imaging device 400 is mounted on the moving object 100 through a gimbal 500 and captures a still image/moving image in response to an input from the user during autonomous movement of the moving object 100. The imaging device 400 is not an essential configuration.

The information processing system 1000 performs speed control of the moving object 100 and the imaging device 400 can perform imaging during movement of the moving object 100. In description of the embodiment, a “position” includes a “posture” not only in a translation direction but also in a rotation direction. A “speed” includes an “angular velocity” not only in a translation direction but also in a rotational direction.

### [1-2. Configuration of Moving Object 100]

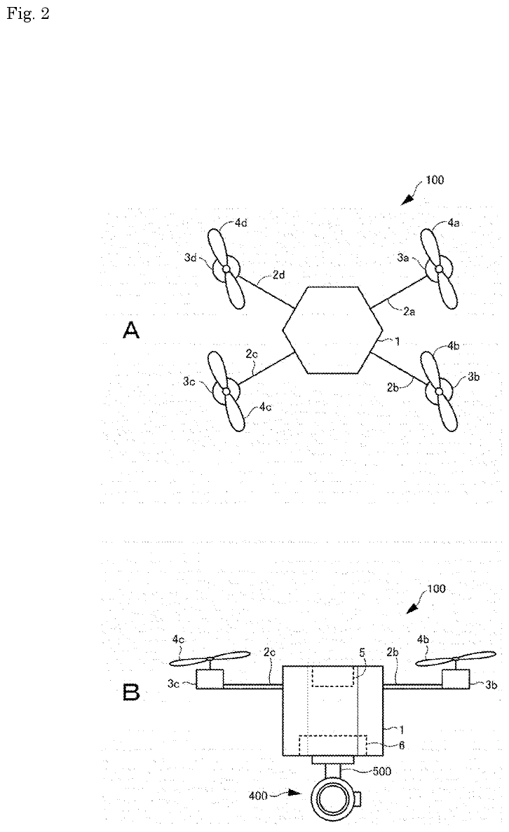

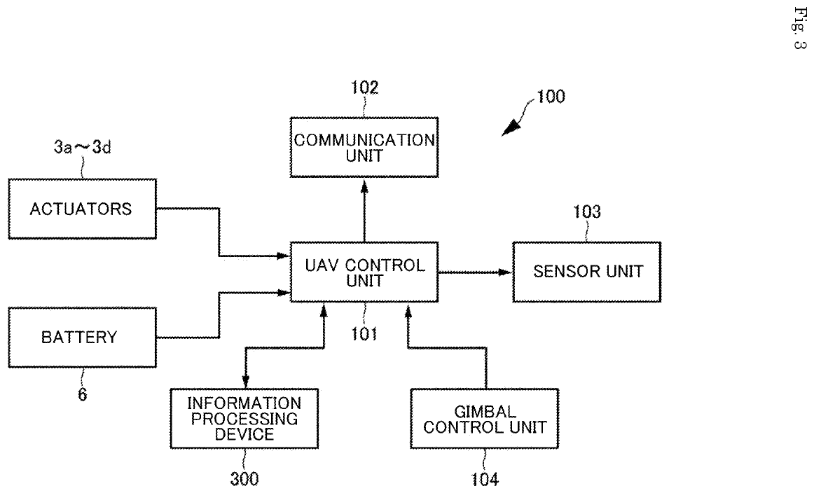

A configuration of the moving object 100 will be described with reference to FIGS. 2 and 3. FIG. 2A is an external plan view of the moving object 100 and FIG. 2B is an external front view of the moving object 100. As a central unit, for example, an airframe is configured by a cylindrical or rectangular cylindrical body unit 1 and supporting shafts 2a to 2d fixed to the upper portion of the body unit 1. For example, the four supporting shafts 2a to 2d are formed to extend radially from the center of the body unit 1. The body unit 1 and the supporting shafts 2a to 2d are formed of a lightweight material with high strength, such as a carbon fiber.

Further, for the airframe formed by the body unit 1 and the supporting shafts 2a to 2d, a shape, disposition, and the like of each constituent component are designed so that the center of gravity of the airframe falls on a vertical line passing through the centers of the supporting shafts 2a to 2d. Further, a circuit unit 5 and a battery 6 are provided inside the body unit 1 so that their centers of gravity fall on its vertical line.

In the example of FIG. 2, the numbers of rotary wings and actuators are four, but the numbers of rotary wings and actuators may be four or more, or less.

Actuators 3a to 3d serving as driving sources of the rotary wings are mounted on the tip ends of the supporting shafts 2a to 2d. Rotary wings 4a to 4d are mounted on rotational shafts of the actuators 3a to 3d. The circuit unit 5 including a UAV control unit 101 that controls each actuator is mounted in a central portion at which the supporting shafts 2a to 2d intersect each other.

The actuator 3a and the rotary wing 4a are paired and the actuator 3c and the rotary wing 4c are paired. Similarly, the actuator 3b and the rotary wing 4b are paired and the actuator 3d and the rotary wing 4d are paired.

The battery 6 serving as a power source is disposed on the bottom surface inside the body unit 1. The battery 6 includes, for example, a lithium ion secondary cell and a battery control circuit that controls charging and discharging. The battery 6 is detachably mounted inside the body unit 1. Stability of the center of gravity is enhanced by matching the center of gravity of the battery 6 with the center of gravity of the airframe.

In general, a small electric flying body called a drone can perform desired navigation by controlling outputs of the actuators. For example, in a hovering state in which the electric flying body is stopped in the air, the airframe remains horizontal by detecting an inclination using a gyro sensor mounted on the airframe, increasing outputs of the actuators on the lower side of the airframe, and decreasing outputs of the actuators on the upper side. Further, when moving forward, by decreasing outputs of the actuators in the traveling direction and increasing outputs of the actuators in the opposite direction, a forward bending posture is taken to generate propulsion power in the traveling direction. In the posture control and the propulsion control of the electric flying body, stability of the airframe and easiness of the control can be in balance at a position at which the above-described battery 6 is installed.

FIG. 3 is a block diagram illustrating a configuration of the moving object 100. The moving object 100 includes an unmanned aerial vehicle (UAV) control unit 101, a communication unit 102, a sensor unit 103, a gimbal control unit 104, an information processing device 300, the battery 6, and the actuators 3a to 3d. The supporting shafts, the rotary wings, and the like described in the outer appearance configuration of the moving object 100 will be omitted. The UAV control unit 101, the communication unit 102, the sensor unit 103, the gimbal control unit 104, and the information processing device 300 are assumed to be included in the circuit unit 5 illustrated in the external view of the moving object 100 in FIG. 2.

The UAV control unit 101 includes a central processing unit (CPU), a random access memory (RAM), and a read-only memory (ROM). The ROM stores programs or the like read and operated by the CPU. The RAM is used as a work memory of the CPU. The CPU controls the entire moving object 100 and each unit by performing various processes and issuing commands in accordance with the programs stored in the ROM. The UAV control unit 101 controls a movement speed, a movement direction, a turning direction, and the like of the moving object 100 by supplying control signals used to control outputs of the actuators 3a to 3d to the actuators 3a to 3d.

The UAV control unit 101 retains preset precedent trajectory information and controls the moving object 100 such that the moving object 100 moves along a precedent trajectory by controlling outputs of the actuators 3a to 3d while acquiring present positional information of the moving object 100 from the sensor unit 103 at any time and comparing a present position of the moving object 100 with the precedent trajectory.

The communication unit 102 is any of various communication terminals or communication modules transmitting and receiving data to and from the input device 200 and the imaging device 400. The communication is wireless communication such as a wireless local area network (LAN), a wide area network (WAN), wireless fidelity (WiFi), a 4th generation mobile communication system (4G), a 4th generation mobile communication system (5G), Bluetooth (registered trademark), or ZigBee (registered trademark) with which the input device 200 can perform communication. The communication with the imaging device 400 may be wired communication such as Universal Serial Bus (USB) communication as well as wireless communication.

The sensor unit 103 is a sensor such as a Global Positioning System (GPS) module that can detect a position of the moving object 100. The GPS is a system that finds a present position by allowing a receiver to receive signals from a plurality of artificial satellites located around the earth. Positional information of the moving object 100 detected by the sensor unit 103 is supplied to the information processing device 300. The information processing device 300 can recognize the position of the moving object 100 from the positional information and can also detect a speed of the moving object 100 from a change in the positional information and an elapsed time.

The sensor unit 103 may include a sensor such as a stereo camera or a laser imaging detection and ranging (LiDAR) sensor that can measure a distance, in addition to the GPS. The stereo camera which is a kind of distance sensor is a stereo type camera that includes two left and right cameras in which the principle of triangulation is applied when a human being sees an object. Parallax data can be generated using image data captured with a stereo camera and a distance between a camera (lens) and a target surface can be measured. The LiDAR sensor measures scattered light of a radiated laser emitted with a pulse shape and analyzes a distance to a target located away from it and a property of the target.

The sensor unit 103 may include a sensor such as an inertial measurement unit (IMU) module that detects an angular velocity. The IMU module is an inertial measurement device and detects a posture or an inclination of the moving object 100, an angular velocity at the time of turning, an angular velocity around the Y axis, and the like by allowing an acceleration sensor, an angular velocity sensor, a gyro sensor, or the like to obtain an acceleration at a 3-dimensional angular velocity in biaxial or triaxial directions.

Further, the sensor unit 103 may include an altimeter or an azimuth meter. The altimeter measures an altitude at which the moving object 100 is located and supplies altitude data to the UAV control unit 101, and may be a pressure altimeter, a radio altimeter, or the like. The azimuth meter detects a traveling azimuth of the moving object 100 using an operation of a magnet and supplies the traveling azimuth to the UAV control unit 101 or the like.

The gimbal control unit 104 is a processing unit that controls an operation of the gimbal 500 for rotatably mounting the imaging device 400 on the moving object 100. By allowing the gimbal control unit 104 to control rotation of a shaft of the gimbal 500, it is possible to adjust a direction of the imaging device 400 freely. Thus, it is possible to adjust the direction of the imaging device 400 in accordance with a set composition and perform imaging.

According to the embodiment, the imaging device 400 is mounted in the lower portion of the moving object 100 via the gimbal 500. The gimbal 500 is a kind of rotating base that rotates an object (the imaging device 400 in the embodiment) supported with, for example, a biaxial or triaxial shaft.

A configuration of the information processing device 300 will be described below.

### [1-3. Configuration of Input Device 200]

### [1-3-1. First Exemplary Configuration of Input Device 200]

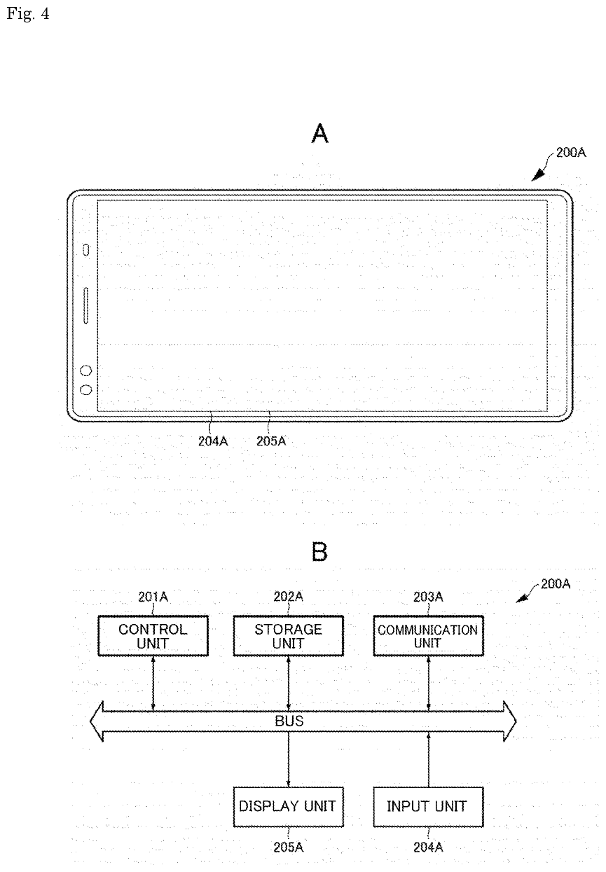

Next, a configuration of the input device 200 will be described. An input device 200A which is a first example is a terminal device such as a smartphone illustrated in FIG. 4A. As illustrated in FIG. 4B, the input device 200A includes a control unit 201A, a storage unit 202A a communication unit 203A, an input unit 204A, and a display unit 205A.

The control unit 201A includes a CPU, a RAM, and a ROM. The CPU controls the entire input device 200A and each unit by performing various processes and issuing commands in accordance with the programs stored in the ROM.

The storage unit 202A is, for example, a large-capacity storage medium such as a hard disk or a flash memory. The storage unit 202A stores various applications, data, and the like used in the input device 200A.

The communication unit 203A is a communication module that transmits and receives data or various signals to and from the moving object 100, the information processing device 300, and the imaging device 400. A communication method may be any method as long as the method is wireless communication such as wireless LAN, a WAN, WiFi, 4G, 5G, Bluetooth (registered trademark), or ZigBee (registered trademark) with which the moving object 100 and the imaging device 400 located away from it can perform communication.

The input unit 204A is used to manipulate the input device 200A and for a user to input an input value to perform speed control or the like of the moving object 100. When the user performs input on the input unit 204A, a control signal is generated in response to the input and is supplied to the control unit 201A. Then, the control unit 201A performs various processes corresponding to the control signals. When an instruction is input to the information processing device 300 and/or the imaging device 400, input content is transmitted to the information processing device 300 or the imaging device 400 through communication of the communication unit 203A. The input unit 204A includes a physical button and a touch panel integrated with a display which is a display unit 205A. The input device 200A may have a sound input function through sound recognition.

The display unit 205A is a display device such as a display that displays an image/video, a graphical user interface (GUI), and the like. In the embodiment, the display unit 205A displays a speed control user interface (UI), a waypoint input UI, and the like of the moving object 100. The input device 200A may include a speaker or the like outputting a sound as output means other than the display unit 205A.

A terminal device functioning as the input device 200A may be a tablet terminal, a notebook-type PC, a portable game device, or a wearable device instead of a smartphone.

Next, a speed control UI in the input device 200A will be described. In the embodiment, the user inputs an input value with the input device 200A, and the information processing device 300 performs speed control of the moving object 100 based on a magnifying power of a speed which is a speed control value based on the input value.

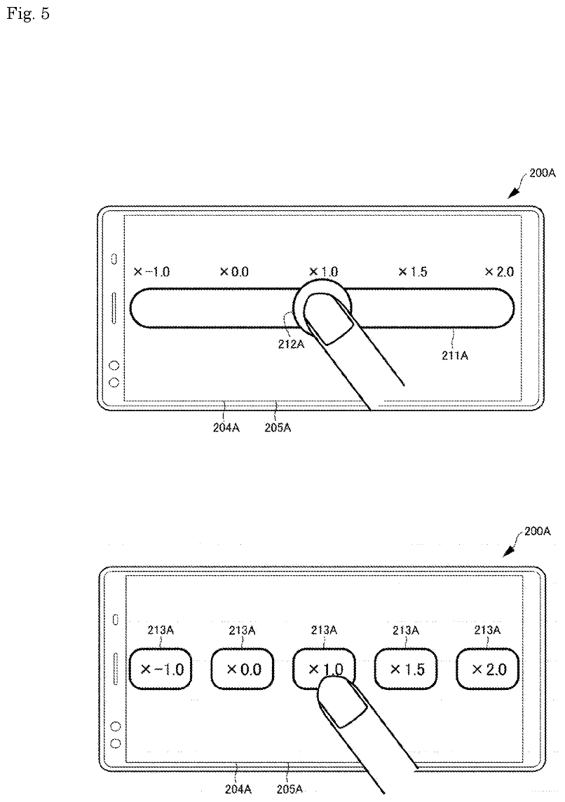

In the description, as illustrated in FIG. 5A, the input unit 204A is assumed to be a touch panel integrated with the display serving as the display unit 205A.

FIG. 5A illustrates an example of a first speed control UI displayed on the display unit 205A. The first speed control UI is configured by a linear input region 211A and a position on the input region 211A corresponds to a magnifying power as a speed control value. On the input region 211A, a slider 212A indicating a present magnifying power is displayed. The slider 212A is slid on the input region 211A in response to an input from the user. By using the configuration of this slider, it is possible to input continuous values.

In the example of FIG. 5A, the right end corresponds to a maximum value “×2.0” of the magnifying power and the right end correspond to a minimum value “×−1.0” of the magnifying power. A space between “×2.0” at the left end and “×−1.0” at the right end correspond to values equal to or less than “×2.0” and equal to or greater than “×−1.0.” The user can designate a magnifying power corresponding to a position of the input region 211A by touching the input region 211A with a finger. The specific magnifying powers illustrated in FIG. 5A are merely exemplary and the present technology is not limited to these values.

A numerical value serving as a reference of the magnifying power corresponding to a position of the input region 211A may be displayed in the vicinity (the upper side in FIG. 5A) of the input region 211A on the first speed control UI. Thus, the user can easily understand where to touch the input region 211A with a finger to designate a target magnifying power. Since a region between positions at which numerical values indicating magnifying powers are displayed also corresponds to magnifying powers on the first speed control UI, the user can designate a magnifying power seamlessly.

When the user takes her or his finger off the input region 211A on the first speed control UI, a magnifying power may automatically transition to a predetermined value, for example, “×1.0,” irrespective of where the finger has touched the input region 211A until then. Thus, when the user takes her or his finger off the input region 211A, the moving object 100 transitions to a preset given speed and moves.

When the user takes her or his finger off the input region 211A on the first speed control UI, a magnifying power corresponding to the position of the input region 211A where the finger has touched until then may be maintained.

FIG. 5B illustrates an example of a second speed control UI displayed on the display unit 205B. The second speed control UI is configured by a plurality of individual button-shaped input regions 213A, 213A, . . . and each of the individual input regions 213A corresponding to different magnifying power. Thus, the second speed control UI is different from the first speed control UI in a scheme of directly designating a magnifying power as a discrete value.

In the second speed control UI, a magnifying power designated by the user and undesignated magnifying powers may be distinguished visually. For example, the designated magnifying power may be displayed more brightly than the unselected magnifying powers.

As described in the first speed control UI, when the user takes her or his finger off any one input region 213A on the second speed control UI, a magnifying power of the speed may also automatically transition to a predetermined value, for example, “×1.0,” irrespective of where the finger has touched the input region 213A until then. Thus, when the user takes her or his finger off the input region 213A despite any speed, the moving object 100 transitions to a preset given speed and moves.

When the user also takes her or his finger off the input region 213A on the second speed control UI, a magnifying power corresponding to the position of the input region 213A where the finger has touched until then may be maintained.

On the second speed control UI, it is easy to designate a magnifying power which is a specific value.

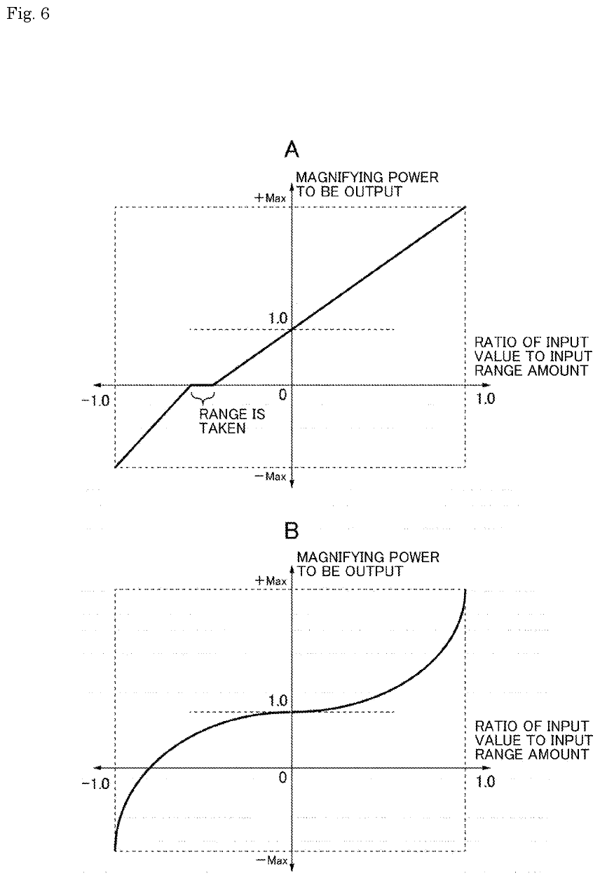

Here, a relation between an input value input from the user and a magnifying power actually output from the input device 200 will be described. FIGS. 6A and 6B are graphs illustrating relations between input values and magnifying powers to be output.

In FIGS. 6A and 6B, the horizontal axis represents a ratio of an input value to an input range amount and takes values from +1.0 to −1.0. The right end is +1.0 which is a maximum value and the left end is −1.0 which is a minimum value. The input range amount is a range from the upper limit and the lower limit of a magnifying power which can be input with the input device 200.

The vertical axis represents a magnifying power to be output by the input unit 204A based on an input value. The upper end of the vertical axis is a maximum value (+Max) of the magnifying power in the positive direction and the lower end is a minimum value (−Max) of the magnifying power in the negative direction.

When the maximum value of the magnifying power in the positive direction is +Max (>1), a magnifying power for an input in the positive direction reaches from 1.0 to +Max linearly, as illustrated in FIG. 6A, or in any curve shape, as illustrate in FIG. 6B, with respect to a difference from the zero point.

Similarly, When the maximum value of the magnifying power in the negative direction is −Max (<0), a magnifying power for an input in the negative direction reaches from 1.0 to −Max linearly, as illustrated in FIG. 6A, or in any curve shape, as illustrate in FIG. 6B, with respect to a difference from the zero point.

When a human being normally reduces a movement speed instinctively in manipulation of the moving object 100, a fine and delicate manipulation is necessary in many cases. Therefore, a resolution of an input manipulation is preferably high. On the other hand, when a movement speed is set to be fast, a fine and delicate manipulation is not necessary in many cases. Therefore, it is preferable to raise a speed with a short manipulation stroke and in a short time despite a low resolution of an input manipulation. Accordingly, by changing a magnifying power in a function with a curved shape illustrated in FIG. 6B, it is possible to realize a manipulation feeling. A function expressed in a straight line or a curved line determining a magnifying power to be output based on an input value from the user in this way is magnifying change information to be described below.

The seamless input method illustrated in FIG. 5A is advantageous because a magnifying power is raised and lowered instinctively. However, there is concern of a magnifying power being difficult to accurately match to a specific value. Accordingly, magnification of a speed has a range at a ratio of the input value which becomes a specific value, as illustrated in FIG. 5A. Thus, a width is set in an input of setting a magnifying power to a specific value. Therefore, the input of setting the magnifying power to the specific value is easy. As the specific value, for example, there are a magnifying power of “0.0” at which a speed of the moving object 100 is 0 (a stopping state), a magnifying power of “1.0” at which a speed of the moving object 100 is a reference speed, and the like. In FIG. 6A, the ratio of the input value takes a range so that an input of setting the magnifying power to 0 is easy.

The input device 200A may include a notification control unit that notifies the user that the ratio of the input value to the input range amount is within a range in which the magnifying power is a predetermined value and is outside of the range. Thus, the user can reliably recognize that a her or his input is an input of designating a predetermined magnifying power. As the notification of the notification control unit, any method may be used as long as the method is a method of allowing the user to recognize the input, such as vibration of the input device 200A, an indication of a message on the display unit 205B, or an output of a sound message.

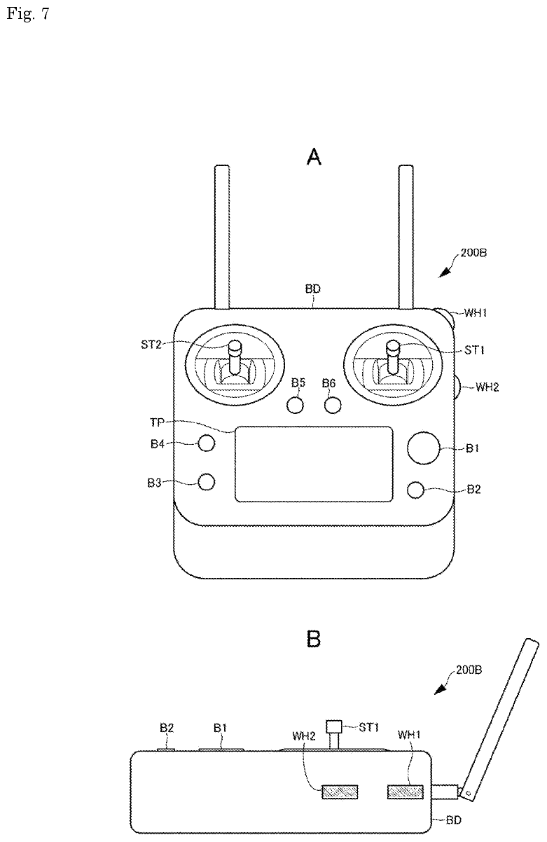

For a physical switch such as a wheel or a lever in the input device 200B to be described below in FIG. 7, the user does not perform an input while seeing the physical switch but performs the input with a feeling of her or his finger. Therefore, there is concern of the magnifying power being also difficult to accurately match to a specific value in the physical switch. Accordingly, similarly to the above-described speed control UI, the range may be provided in an input value at which magnification of a speed is a specific value. The input device 200B may include a notification mechanism that notifies the user that an input is within a range in which the magnifying power is the predetermined value and is outside of the range. Thus, the user can reliably recognize that a her or his input is an input of designating a predetermined value. As the notification mechanism, there are a claw-shaped mechanism providing a clicking feeling to the physical switch by connection, a vibration mechanism of the entire input device 200B, and the like.

### [1-3-2. Second Exemplary Configuration of Input Device 200]

Next, a second example of the input device 200 will be described. The input device 200B which is a second example of the input device 200 is a manipulation-dedicated hardware controller of the moving object 100, as illustrated in FIG. 7. Since a block configuration of the input device 200B is the same as that of the input device 200A, FIG. 4B is quoted and description thereof will be omitted.

The input device 200B includes a casing BD, sticks ST1 and ST2, buttons B1 to B6, a touch panel TP, and wheels WH1 and WH2 (which may be called dials). All the sticks ST1 and ST2, the buttons B1 to B6, the touch panel TP, and the wheels WH1 and WH2 correspond to an input unit 204A in the block diagram illustrated in FIG. 4B.

The sticks ST1 and ST2 can be manipulated with the thumbs of the user to be pushed down in at least one of the upper and lower directions (the vertical direction or the lengthwise direction) and the right and left directions (the horizontal direction or the transverse direction), and thus are used, for example, to give an instruction for a movement direction or a turning direction of the moving object 100. The sticks ST1 and ST2 may be configured to be pushed down in a diagonal direction.

For example, when the user pushes down the stick ST1 upwards, the moving object travels forwards. When the user pushes down the stick ST1 downwards, the moving object 100 travels backwards. When the user pushes down the stick ST1 leftwards, the moving object 100 turns to the left. When the user pushes down the stick ST1 rightwards, the moving object 100 turns to the right.

Further, when the user pushes down the stick ST2 upwards, the moving object 100 moves up. When the user pushes down the stick ST2 downwards, the moving object 100 moves down. When the user pushes down the stick ST2 leftwards, the moving object 100 moves leftwards. When the user pushes down the stick ST2 rightwards, the moving object 100 moves rightwards. The manipulations on the sticks ST1 and ST2 are merely exemplary. The manipulations on the sticks ST1 and ST2 may be reverse or other operations of the moving object 100 may be allocated. The number of sticks is merely exemplary and the present technology is not limited to the number of sticks.

The manipulations of the moving object 100 and various functions related to control can be allocated to the buttons B1 to B6. For example, a function of turning power on/off or the like is allocated. The number of buttons is merely exemplary and the present technology is not limited to the number of buttons.

The touch panel TP displays information regarding the moving object 100 to present the information to the user and is used for the user to input various instructions.

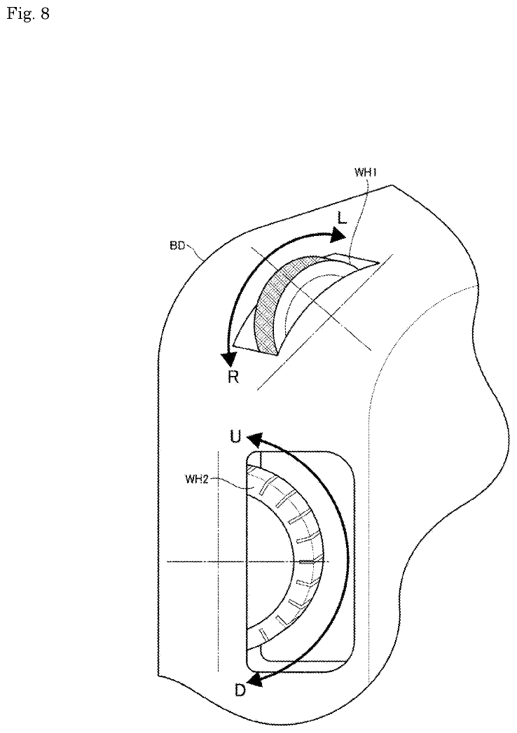

The wheels WH1 and WH2 are input mechanisms with which continuous values can be input in the positive and negative directions. The wheels WH1 and WH2 are provided to be partially exposed to the side surface of the casing BD, as illustrated in the partially expanded drawing of FIG. 8. The wheel WH1 is configured to be rotatable in R and L directions. The wheel WH1 is a wheel in which the direction from the front surface to the rear surface of the casing BD serves as an axis and has a structure in which a manipulation is easy in a shoulder portion of the casing BD. The wheel WH2 is configured to be rotatable in U and D directions. The wheel WH2 is a wheel in which the right and left directions of the side surface of the casing BD serves as an axis and has a structure in which a manipulation is easy in the side surface of the casing BD. The wheels WH1 and WH2 are provided on the upper side surface and the lateral side surface of the casing BD so that the user can manipulate the wheels with a finger (for example, a forefinger or a middle finger) different from fingers manipulating the sticks ST1 and ST2. When it is not necessary to distinguish the wheels WH1 and WH2 from each other in the following description, the wheels WH1 and WH2 are referred to as the wheels WH.

For the wheel WH, for example, an input of rightward rotation (clockwise rotation) corresponds to a positive (positive direction) magnifying power and an input of leftward rotation (counterclockwise rotation) correspond to a negative (negative direction) magnifying power. A rotational amount of the wheel WH corresponds to the value of a magnifying power. As the rotational amount in the rightward rotation direction is larger, a larger positive value of the magnifying power can be input. As the rotational amount in the leftward rotation direction is larger, a larger negative value of the magnifying power can be input. Thus, the user can simultaneously give a manipulation instruction to adjust a speed with the sticks ST1 and ST2 while giving an instruction for a manipulation in a movement direction and a turning direction of the moving object. The rightward rotation direction may correspond to a negative value and the leftward rotation direction may correspond to a positive value.

A mechanism may be provided to give a notification so that the user can recognize the degree of rotation of the wheel WH corresponding to a predetermined magnifying power (for example, 1.0 times at which a speed of the moving object is a pre-decided speed). As the notification mechanism, there is a claw-shaped mechanism giving a click feeling by giving a hooking to rotation of the wheel WH or a vibration mechanism vibrating the entire input device 200B, or the like. Thus, the user can recognize that the user inputs a predetermined magnifying power although the user does not see the magnifying power.

The wheel WH may include a return mechanism returning to a predetermined state (for example, a state in which a magnifying power is 1.0) when a manipulating finger is taken off. When the wheel WH does not automatically return, it is necessary for the user to visually check an input value, and thus a visual line becomes away from the moving object 100 or a captured image. Accordingly, it is desirable to include the return mechanism in the wheel WH. The return mechanism can be configured by normally urging the wheel WH in a direction of a predetermined state using an elastic body such as a spring. A magnifying power inputting wheel may be any of the wheels WH1 and WH2 or only one of the wheels WH1 and WH2 may be provided in the casing BD. Further, the wheels WH1 and WH2 may be provided the left side surface of the casing BD. Further, the wheels may be provided on both the right and left side surface of the casing BD.

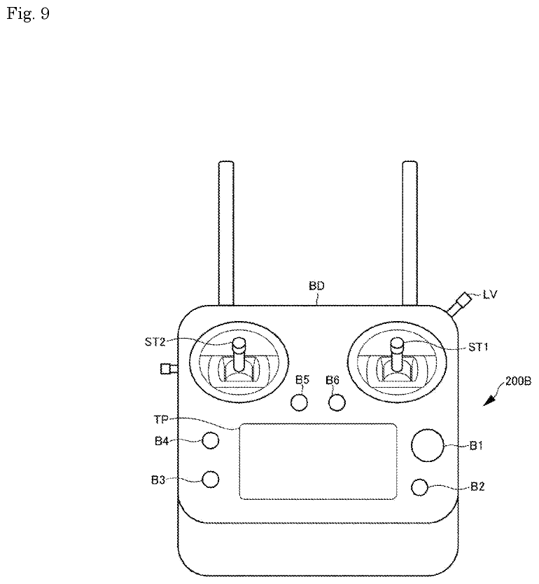

As illustrated in FIG. 9, a lever LV may be provided in the input device 200B instead of the wheels. The lever LV is an input mechanism capable of inputting continuous values like the wheel. The lever LV is provided in the upper side surface of the casing BD so that the user can manipulate the lever with a finger (for example, a forefinger) different from a finger manipulating the stick ST1, as in the above-described wheel.

For the lever LV, for example, a rightward input corresponds to a positive magnifying power and a leftward input corresponds to a negative magnifying power. The degree that the lever LV is pushed down corresponds to a magnifying power. When the degree of pushing in the rightward rotation direction is large, a larger positive value of the magnifying power can be input with the lever LV. When the degree of pushing in the leftward rotation direction is large, a larger negative value of the magnifying power can be input with the lever LV. The rightward pushing-down may correspond to a negative value and the leftward pushing-down may correspond to a positive value. The lever LV may also include a notification mechanism as in the wheel.

The lever LV may include a return mechanism returning to a predetermined state (for example, a state in which a magnifying power is 1.0) when a manipulating finger is taken off as in the wheel WH. Here, the lever LV may not include the return mechanism because an input value can be checked with a feeling of a finger unlike the wheel. Rather, by increasing friction, an erroneous operation may be prevented and an input value may be maintained.

In this way, for either the wheel WH or the lever LV, a mechanism inputting a magnifying power may be a uniaxial operator. In a uniaxial operator, a manipulation of a straight line in two directions can be performed. Therefore, a magnifying power can be input simultaneously with another manipulation (a manipulation of the moving object 100 or a manipulation of the imaging device 400).

The input device 200B may include both the wheel WH and the lever LV.

### [1-4. Configuration and Speed Control Process of Information Processing Device]

### [1-4-1. Precedent Trajectory]

Next, a configuration of the information processing device 300 and a speed control process of the moving object 100 by the information processing device 300 will be described. First, a precedent trajectory will be described before description of the speed control process.

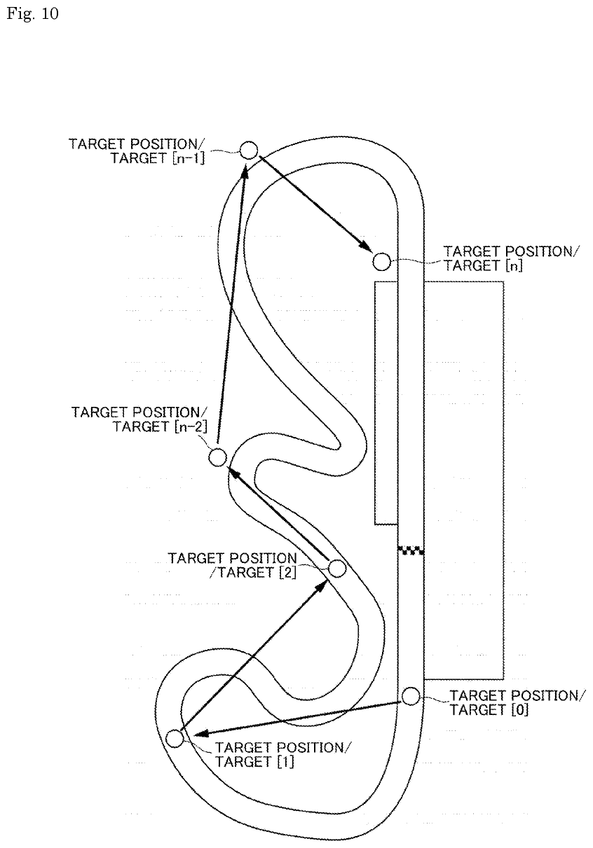

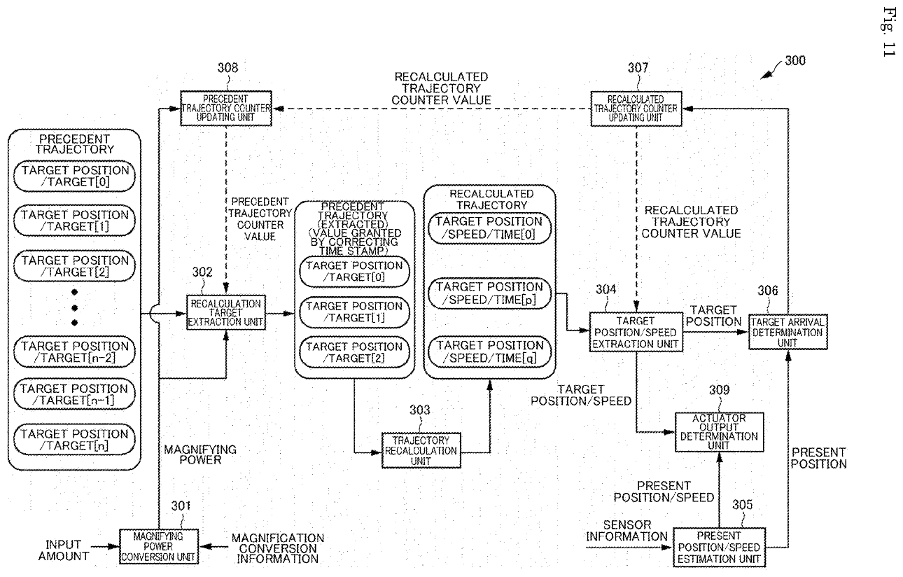

The precedent trajectory is configured by a plurality of “target positions/times” of target positions which are positions through which the moving object 100 passes and target times which are times at which the moving object 100 passes through the target position, as illustrated in FIGS. 10 and 11. The target position is set with, for example, latitude and longitude. The target time may be set to a specific time such as a “01:23:45” or may be set to an elapsed time such as 10 seconds from a reference time (a movement starting time or the like). The moving object 100 performs movement based on the precedent trajectory and the information processing device 300 performs a speed control process based on the precedent trajectory. Accordingly, it is necessary for the user to set the precedent trajectory before actual movement. The precedent trajectory is basically invariant except that the precedent trajectory is considered to be a recalculated trajectory through a recalculation process after all the target positions/times are set, and serves as a reference of movement of the moving object 100.

The precedent trajectory is set as in FIG. 10, for example. In FIG. 10, 2-dimensional map data of a circuit of a racing car is used as an example. A plurality of target positions through the moving object 100 passes and target times which are times at which the moving object 100 passes through the target positions are set each on the 2-dimensional map data. Thus, the precedent trajectory which is a trajectory along which the moving object 100 passes through the target positions in an order in which the target times are earlier is set. Numbers are appended to the target positions/times in an order (time-series) in which the moving object 100 passes. The precedent trajectory may be configured by target positions and target speeds indicating speeds at which the moving object 100 passes through the target positions.

The target positions can be set, for example, by directly designating the target positions in the order in which the moving object 100 passes through positions on map data displayed on the display unit 205A of the input device 200A, another display device, or a terminal device. The target times can be set, for example, by inputting a specific numerical value for each target position. The target positions/times set in this way are supplied as a collection of the precedent trajectory information to the information processing device 300. An input device that sets the precedent trajectory may be the same as the input device 200 or may be a separate device.

The precedent trajectory set in this way is supplied to the UAV control unit 101 of the moving object 100. The UAV control unit 101 moves the moving object 100 along the precedent trajectory by controlling outputs of the actuators 3a to 3d while comparing present positional information of the moving object 100 acquired from the sensor unit 103 with the precedent trajectory.

For example, a case can be considered in which a state of the precedent trajectory is checked by moving the moving object 100 actually along the precedent trajectory before actual imaging performed with the imaging device 400 mounted on the moving object 100. In the speed control of this case, a speed control UI including a button for designating magnification of a speed illustrated in FIG. 5B to a fixed value is appropriate. For example, at a place at which a state of the precedent trajectory is desired to be checked (for example, whether is no obstacle such as a tree) or a position and posture of the moving object 100 is desired to be checked, the state of the precedent trajectory or the position and posture of the moving object 100 can be visually checked in a sufficient time by causing the speed of the moving object 100 to be slower than a preference speed (for example, selecting magnification of 0.5). By causing the speed of the moving object 100 to be faster than the preference speed (for example, selecting the magnification of 2.0 of the speed) at a location at which a motion of the moving object 100 from a target position to another target position in a substantially straight shape is simple, it is possible to shorten a checking work time.

When a speed at which the moving object 100 is moving along the precedent trajectory is checked, the speed control UI for designating continuous values, as illustrated in FIG. 5A, is appropriate. When the fact that “good magnification of a speed at a specific position on the precedent trajectory is about 1.3 times” can be understood by checking the speed, an appropriate target time can be set by causing the target time to correspond the target position in the setting of the precedent trajectory.

To perform flexible and continuous speed control in accordance with a motion of a subject in actual imaging performed with the imaging device 400 mounted on the moving object 100, the speed control UI on which continuous values can be input, as illustrated in FIG. 5A, is appropriate. When the user takes her or his finger off the input region 211A, the moving object 100 continuously moves at a speed suitable for a target time of the precedent trajectory. Therefore, the user can concentrate on a manipulation of a posture of the moving object 100 or a manipulation of the imaging device 400. Further, smooth acceleration or deceleration of the moving object 100 can be performed as necessary. It is not essential to check the precedent trajectory before actual movement of the moving object 100.

The precedent trajectory may be set on 3-dimensional map data. A map service or the like available on the Internet can also be used as 2-dimensional or 3-dimensional map data. The moving object 100 may be actually moved and the precedent trajectory may be set based on a movement route.

### [1-4-2. Configuration and Process of Information Processing Device 300]

Next, a configuration and a speed control process of the information processing device 300 will be described. The information processing device 300 performs a process of controlling a speed of the moving object 100 using a magnifying power which is a speed control value based on an input to the input device 200 from the user. The moving object 100 moves along the target positions/times set in the precedent trajectory as long as there is no input from the user.

As illustrated in FIG. 11, the information processing device 300 includes a magnifying power conversion unit 301, a recalculation target extraction unit 302, a trajectory recalculation unit 303, a target position/speed extraction unit 304, a present position/speed estimation unit 305, a target arrival determination unit 306, a recalculated trajectory counter updating unit 307, a precedent trajectory counter updating unit 308, and an actuator output determination unit 309.

The precedent trajectory is recalculated by the trajectory recalculation unit 303 in a process of the information processing device 300 and is redefined as a recalculated trajectory. As will be described below in detail, the recalculated trajectory is configured by a plurality of target positions, target speeds, and target times (hereinafter referred to as target positions/speeds/times).

The information processing device 300 performs a process based on a value of a precedent trajectory counter indicating a progress state of movement along the precedent trajectory of the moving object 100 and a value of a recalculated trajectory counter indicating a progress of movement in a recalculated trajectory of the moving object 100. The precedent trajectory counter counts a progress state of the moving object 100 based on target position/time numbers configuring the precedent trajectory. A counter value of the precedent trajectory counter is associated with a number appended in order in which the moving object 100 passes at the target positions/times. An initial value of the counter value of the precedent trajectory counter is 0 and increases by 1 whenever the moving object 100 arrives at a new target position.

The recalculated trajectory counter counts a progress state of the moving object 100 based on the target position/speed/time numbers configuring a recalculated trajectory. A counter value of a recalculated trajectory progress counter is associated with a number appended in order in which the moving object 100 passes at target positions/speeds/times. An initial value of the counter value of the recalculated trajectory progress counter is 0 and increases by 1 whenever the moving object 100 arrives at a new target position.

The magnifying power conversion unit 301 converts an input value input to the input device 200 from the user into a magnifying power which is a speed control value based on a pre-decided magnification conversion information and supplies the magnifying power to the recalculation target extraction unit 302 and the precedent trajectory counter updating unit 308. The magnification conversion information is a function of determining a magnifying power to be output based on an input value from the user, as described with reference to FIG. 6.

The recalculation target extraction unit 302 extracts a plurality of target positions/times which are recalculation targets from the precedent trajectory using the magnifying power, the precedent trajectory, and the counter value of the precedent trajectory counter as inputs, and supplies the target positions/times to the trajectory recalculation unit 303. The recalculation target extraction unit 302 extracts a plurality of target positions/times corresponding to the number of seconds R′ calculated with the following Math. 1 from a magnifying power S and a predetermined number of seconds R in positive and negative directions of the magnifying power S using the target position/time of the number indicated by the value of the precedent trajectory counter as a starting point.

R′=|S|×R [Math. 1]

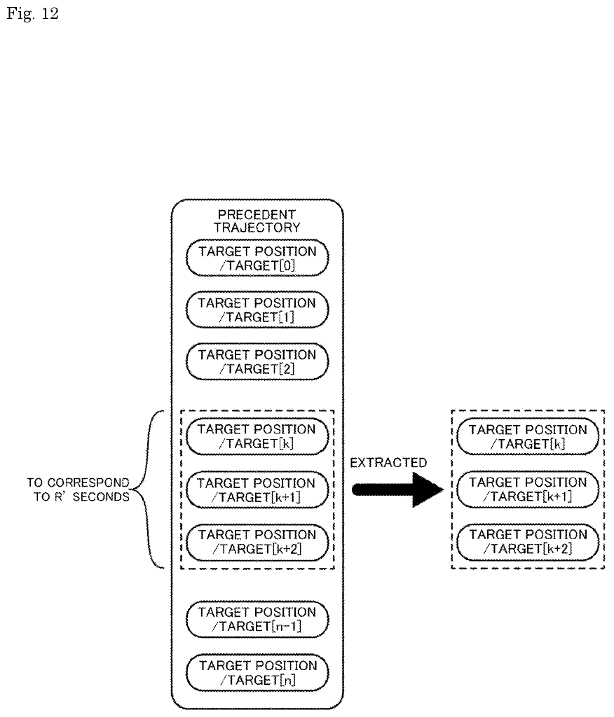

For example, when a counter value of the precedent trajectory counter is K and the target positions/times corresponding to the number of seconds R′ from the target position/time [k] are target positions/times [k+1] and [k+2], as illustrated in FIG. 12, three target positions/times [k], [k+1], and [k+2] are extracted by the recalculation target extraction unit 302.

For the extracted target positions/times, a time stamp is corrected and a number is granted again as a positions/times corresponding to R′ seconds from a reference time (for example, 0). The extracted target positions/times are indicated as a “precedent trajectory (extracted)” in FIG. 11.

When the magnifying power S is 0, R′ is also 0. Therefore, in the above-described process, target positions/times corresponding to 0 seconds cannot be extracted. Accordingly, when the magnifying power S is 0, a plurality of k-th target positions/times with the same number of the counter value k are extracted and arranged. When a counter value of the precedent trajectory counter indicates a starting point or an ending point of the precedent trajectory and further tracking cannot be performed, a plurality of final target positions/times which are the ending point of the precedent trajectory are extracted and arranged.

The trajectory recalculation unit 303 calculates a periodic trajectory (recalculated trajectory) in accordance with a continuous path (CP) control period using the plurality of extracted target positions/times as an input. In a point-to-point (PTP) control motion, a smooth trajectory along which a human being can perform maneuvering cannot be realized. Accordingly, CP control is used in the present technology. By generating a control command value in accordance with the control period of an actuator of the moving object 100 from the designated precedent trajectory and providing the control command value as a target value to the UAV control unit 101, it is possible to realize smoother movement. In this case, a pair of position and time is necessary for the precedent trajectory and a target speed is also determined every time.

The trajectory recalculation unit 303 calculates a target speed which is a speed of the moving object 100 at the time of passing of the target position based on the target position and the target time. The recalculated trajectory is configured by a target position, a target speed, and a target time (target position/speed/time). Here, actually, a “control amount suitable for an actuator controller” has only to be used. When the target positions/times extracted from the precedent trajectory correspond to R′ seconds, the recalculated trajectory calculated by the trajectory recalculation unit 303 may correspond to R′ seconds or may not correspond to R′ seconds. To facilitate description, R′ seconds are all used. However, the number of seconds extracted from the precedent trajectory, the number of second of the recalculated trajectory calculated by the trajectory recalculation unit 303, a ratio between both the numbers of seconds, and the like depend on a CP calculation algorithm.

All the target positions/times are set in advance as the precedent trajectory. Therefore, when a speed of the moving object 100 is changed through the speed control, times of arrival to all the target positions after the time point at which the speed is changed are changed. Thus, the times of arrival to all the target positions after the time point at which the speed is changed are shifted. Accordingly, it is necessary for the trajectory recalculation unit 303 to recalculate the target positions/times, correct the shift, and reset the target positions/times.

Here, a load of a process by the trajectory recalculation unit 303 increases in some cases. Therefore, all the target positions/times are not recalculated, but an extraction range is restricted with the number of seconds R′ by the recalculation target extraction unit 302 and target positions/times within the extraction range are recalculated by the trajectory recalculation unit 303. The target positions/times corresponding to the number of seconds R′ may not be extracted by the recalculation target extraction unit 302, but the extraction may be performed within a range equal to or greater than the number of seconds R′, and the target positions/times corresponding to the number of seconds R′ may be recalculated by the trajectory recalculation unit 303.

The target position/speed extraction unit 304 extracts subsequent target positions/speeds/times at which the moving object 100 is to arrive and which have numbers indicated by the values of the recalculated trajectory counters from the recalculated trajectory calculated by the trajectory recalculation unit 303. The extracted target positions are supplied to the target arrival determination unit 306. The extracted target positions/speeds are supplied to the actuator output determination unit 309.

The present position/speed estimation unit 305 estimates a present position and a present speed of the moving object 100 based on various kinds of sensor information supplied from the sensor unit 103 of the moving object 100. The present position is supplied to the target arrival determination unit 306 and the present position/speed is supplied to the actuator output determination unit 309.

The target arrival determination unit 306 determines whether the moving object 100 arrives at a target position at which the moving object 100 will arrive subsequently from a difference between the target positions and the present position. A determination result of the target arrival determination unit 306 is supplied to the recalculated trajectory counter updating unit 307.

When the moving object 100 arrives at the target position based on the determination result of the target arrival determination unit 306, the recalculated trajectory counter updating unit 307 increases the value of the recalculated trajectory progress counter. The value of the recalculated trajectory counter updated by the recalculated trajectory counter updating unit 307 is supplied to the target position/speed extraction unit 304. Thus, the target position/speed extraction unit 304 extracts the target position/speed with a subsequent number at which the moving object 100 will arrive and which is indicated with the recalculated trajectory counter value at a subsequent extraction timing from the recalculated trajectory. Further, the value of the recalculated trajectory progress counter is also supplied to the precedent trajectory counter updating unit 308.

The precedent trajectory counter updating unit 308 performs a process of increasing or decreasing the precedent trajectory counter based on the value of the recalculated trajectory counter and a positive or negative magnifying power supplied from the magnifying power conversion unit 301. When the magnifying power is a positive value, the precedent trajectory counter updating unit 308 increases the value of the precedent trajectory counter assuming that the moving object 100 has moved in a positive direction (a traveling method along the trajectory). Conversely, when the magnifying power is a negative value, the value of the precedent trajectory counter is decreased assuming that the moving object 100 has moved in a negative direction (a returning direction along the trajectory). The precedent trajectory counter value is supplied to the recalculation target extraction unit 302. Thus, the recalculation target extraction unit 302 extracts the target position/speed with a subsequent number at which the moving object 100 will arrive and which is indicated with the precedent trajectory counter value from the precedent trajectory at a subsequent extraction timing.

The actuator output determination unit 309 is supplied with the target position/speed of the recalculated trajectory and the present position/speed of the moving object 100 estimated by the present position/speed estimation unit 305.

In the case of a position control mode, the actuator output determination unit 309 converts a difference between the target position and the present position into a control signal with which outputs of the actuators 3a to 3d of the moving object 100 are controlled and supplies the control signal to the UAV control unit 101 of the moving object 100. In the case of a speed control mode, the actuator output determination unit 309 converts a difference between the target speed and the present speed into a control signal with which outputs of the actuators 3a to 3d of the moving object 100 are controlled and supplies the control signal to the UAV control unit 101 of the moving object 100. The UAV control unit 101 controls the outputs of the actuators 3a to 3d by transmitting the control signal to the actuators 3a to 3d and controls the movement speed and the movement direction of the moving object 100. Thus, the speed of the moving object 100 is controlled. The control mode of the actuator output determination unit 309 may be determined by the user.

As described above, the information processing device 300 performs the speed control process. The information processing device 300 may performs the above-described process only when there is an input from the user, or may continuously perform the process at a predetermined time interval irrespective of whether there is an input from the user.

According to the present technology, the user can perform inputting to control a speed of the moving object 100. Accordingly, the user can simultaneously designate the speed simply while automatically adjusting the moving object 100.

By providing a plurality of methods of allowing the user to designate the speed, flexible countermeasures can be taken in accordance with broad demands of the user or a broad purposes.

The information processing device 300 may be implemented by executing a program, and the program may be installed in advance in the moving object 100 and may be downloaded and distributed with a storage medium or the like, and the user may install the program by herself or himself. Further, the information processing device 300 may be implemented by a program and may be implemented in combination of a dedicated hardware device with the function, a circuit, and the like.

### [1-5. Configuration of Imaging Device 400]

Next, a configuration of the imaging device 400 will be described. As illustrated in FIGS. 1 and 2B, the imaging device 400 is mounted on the bottom surface of the body unit 1 of the moving object 100 to be suspended via the gimbal 500. The imaging device 400 can perform imaging by orienting a lens in any of all the directions from the horizontal direction to the vertical direction of 360 degrees through driving of the gimbal 500. Thus, the imaging can be performed at a set composition. An operation of the gimbal 500 is controlled by the gimbal control unit 104.

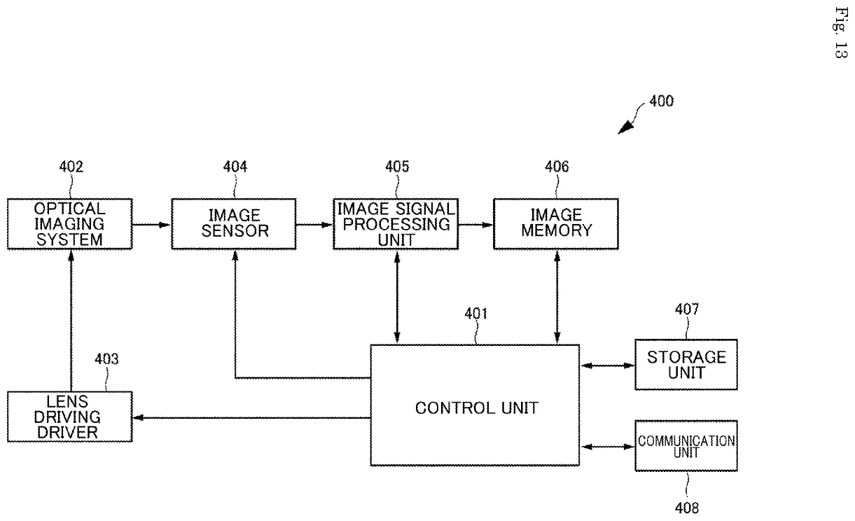

The configuration of the imaging device 400 will be described with reference to the block diagram of FIG. 13. The imaging device 400 includes a control unit 401, an optical imaging system 402, a lens driving driver 403, an image sensor 404, an image signal processing unit 405, an image memory 406, a storage unit 407, and a communication unit 408.

The optical imaging system 402 includes an imaging lens that condense light from a subject on the image sensor 404, a driving mechanism that moves the imaging lens to perform focusing or zooming, a shutter mechanism, and an iris mechanism. These are driven based on control signals from the control unit 401 and the lens driving driver 403 of the imaging device 400. An optical image of a subject obtained via the optical imaging system 402 is formed on the image sensor 404 included in the imaging device 400.

The lens driving driver 403 is configured by, for example, a microcomputer and performs autofocus to focus a targeting subject by moving the imaging lens by a predetermined amount in an optical axis direction under the control of the control unit 401. Under the control of the control unit 401, the driving mechanism, the shutter mechanism, the iris mechanism, and the like of the optical imaging system 402 are controlled. Thus, adjustment of an exposure time (a shutter speed) and adjustment of a diaphragm value (an F value) or the like are performed.

The image sensor 404 photoelectrically converts incident light from the subject into a charge amount and outputs a pixel signal. The image sensor 404 outputs the pixel signal to the image signal processing unit 405. A charge coupled device (CCD), a complementary metal oxide semiconductor (CMOS), or the like is used as the image sensor 404.

The image signal processing unit 405 generates an image signal by performing sampling and holding for maintaining a signal/noise (S/N) ratio satisfactorily through a correlated double sampling (CDS) process, an auto gain control (AGC) process, analog/digital (A/D) conversion, and the like on an imaging signal output from the image sensor 404.

The image memory 406 is a volatile memory, for example, a buffer memory configured by a dynamic random access memory (DRAM). The image memory 406 temporarily stores image data subjected to a predetermined process by the image signal processing unit 405.

The storage unit 407 is, for example, a large-capacity storage medium such as a hard disk, a USB flash memory, or an SD memory card. Captured images are stored in a compressed state or an uncompressed state, for example, based on a standard such as Joint Photographic Experts Group (JPEG). Exchangeable Image File Format (EXIF) data including additional information such as information regarding a stored image, imaging positional information indicating an imaging position, and imaging time information indicating an imaging date and time is also stored in association with the images.

The communication unit 408 is any of various communication terminal or a communication module that transmits and receives data to and from the moving object 100 and the input device 200. The communication may be any of wired communication such as USB communication or wireless communication such as wireless LAN, WAN, WiFi, 4G 5G, Bluetooth (registered trademark), or ZigBee (registered trademark).

The user may be allowed to manipulate the imaging device 400 using the input device 200 in addition to a manipulation on the moving object 100 or may be allowed to manipulate the imaging device 400 using a device different from the input device 200.

According to the present technology, the user can easily perform inputting to control a speed of the moving object 100. Thus, when the imaging device 400 is mounted on the moving object 100 to perform imaging, the user can perform inputting to control a speed of the moving object 100 while manipulating the imaging device 400. Accordingly, for example, even when the user is a maneuverer who is not exclusively accustomed to the moving object 100 and is a cameraman for a one-operation, the user who is a cameraman can focus on framing or focusing while easily performing inputting to control the speed of the moving object 100.

It is possible to adjust the speed while moving the moving object 100 along a precedent trajectory which is previously set, and thus it is possible to minutely adjust a positional relation between the imaging device 400 and a subject in actual imaging. To perform continuous speed control flexibly in accordance with a motion of a subject in actual imaging, it is desirable to use a UI on which continuous values can be input, as illustrated in FIG. 5A or 8. When there is no input, for example, a finger is taken off, the moving object 100 continues to move at 1-time speed. Therefore, it is possible to further concentrate on camera work. As necessary, smooth acceleration or deceleration can be performed in accordance with an input.

As a specific example of a usage mode of the present technology, an example in which a drone performs aerial imaging of a racing car circulating on a circuit field as the moving object 100 can be exemplified. A traveling line and a speed distribution of an ideal racing car in a specific race can be assumed previously. The assumed information can be used to determine a precedent trajectory of the drone like a “lane” as a flying line for performing ideal imaging.

A cameraman can accelerate or decelerate a drone moving along a “lane” with one lever to adjust a distance and a direction with respect to a subject using the present technology, while focusing on a framing manipulation with a pan-tilt-zoom camera mounted on the drone moving on the “lane.”

For example, when a certain racing car is assumed to go off course and thus stop, stopping or backward moving of the drone can be performed with a manipulation on the input device 200 to continue the imaging while maintaining an appropriate position. The manipulation on the drone may be converted into a manual manipulation.

### 2. Modified Examples

The embodiment of the present technology has been described specifically, but the present technology is not limited to the above-described embodiment and various modifications can be made based on the technical sprit and essence of the present technology.

In the embodiment, the magnifying power has been used as a speed control value, but a numeral value of a specific speed can be designated as the speed control value and a speed can be adjusted with an offset value as well. For example, a speed such as +1 km/h, +2 km/h, or +3 km/h to be added may be directly designated as a present speed or a movement speed such as 43 km/h or 50 km/h of the moving object 100 may be directly designated. In this case, a speed of the moving object 100 is controlled by addition/subtraction. When the speed control value is a magnifying power, a speed of the moving object is determined by multiplication.

In the embodiment, the example in which the imaging device 400 is mounted on the moving object 100 has been described. However, the present technology can be applied to speed control of the moving object 100 on which another device is mounted rather than the imaging device 400 and can also be applied to speed control of the moving object 100 on which no other device is mounted.

In the embodiment, the moving object 100 and the imaging device 400 may be separate devices. However, the moving object 100 and the imaging device 400 may be configured as an integrated device.

A drone serving as the moving object 100 is not limited to a drone that has the rotary wings described in the embodiment, but may be a so-called fixed wing type of drone.

The moving object 100 according to the present technology is not limited to a drone, but may be an automobile, a ship, a robot, a wheelchair, or the like which is not maneuvered by a human being and autonomously moves. A semi-moving object that is maneuvered by a human being and or can autonomously move may be used.

In the second exemplary configuration of the input device 200, the wheels WH1 and WH2 have been included, as described above, but the number of wheels is not limited to two. For example, a wheel that has upper and lower directions of the casing BD as an axis or a wheel that is manipulated to the right and left with a middle finger on the rear surface of the casing BD may be provided as a wheel WH3. Further, apart from a wheel shape, a slide type of input mechanism which can be implemented with a thin structure may be provided.

The imaging in which the present technology is used can be used for broad purposes such as movies or sports. In the embodiment, the aerial imaging performed with a drone has been exemplified, but the present technology can also be applied to, for example, a lane moving camera in which grounding is assumed like athletics track sports besides.

Any device may be used as the imaging device 400 as long as the device such as a digital camera, a smartphone, a mobile phone, a portable game device, a notebook-type PC, a tablet terminal which has an imaging function and can be mounted on the moving object 100.

The imaging device 400 may include an input unit and a display unit. When the imaging device 400 is not connected to the moving object 100, the imaging device 400 may be usable as a single imaging device.

The information processing device 300 may be provided not in the moving object 100 but in the input device 200.

The present technology can be configured as follows.

(1)

An information processing system including:

an information processing device configured to control a speed of a moving object that autonomously moves along a preset trajectory; and

an input device including an input unit that receives an input from a user and configured to supply an input value input from the user and used to control the speed of the moving object to the information processing device.

(2)

The information processing system according to (1),

wherein the moving object autonomously moves to pass through an arbitrary target position preset on the trajectory at a preset target time or target speed, and

wherein the information processing device controls a speed by updating the target position and/or the target speed based on a speed control value obtained from the input value.

(3)

The information processing system according to (2), wherein the speed of the moving object is controlled based on a difference between the updated target speed and a present speed of the moving object.

(4)

The information processing system according to (2), wherein the speed of the moving object is controlled based on a difference between the updated target position and a present position of the moving object.

(5)

The information processing system according to any one of (1) to (4), wherein the input unit is configured by a uniaxial operator.

(6)

The information processing system according to (5), wherein the input unit is configured by a wheel and/or a lever.

(7)

The information processing system according to any one of (1) to (6), wherein the input unit is configured by a touch panel that has an input region of the input value.

(8)

The information processing system according to (7), wherein the input region of the input value is configured in a slider shape in which continuous values are able to be input.

(9)

The information processing system according to (7), wherein the input region of the input value is configured in a button shape in which discrete values are able to be input.

(10)

The information processing system according to any one of (1) to (9), wherein a range is provided for the input value for performing control such that the speed of the moving object becomes a predetermined speed.

(11)

The information processing system according to any one of (1) to (10), wherein the input device includes a notification unit that notifies the user that the input from the user is within and/or outside of the range of the input value.

(12)

The information processing system according to any one of (1) to (11), wherein the input unit includes a notification unit that notifies the user that the input from the user is the input value at which the speed of the moving object is a predetermined speed.

(13)

The information processing system according to any one of (1) to (12), wherein the speed is controlled based on a magnifying power of a speed serving as the speed control value.

(14)

The information processing system according to any one of (1) to (13), wherein the speed is controlled based on a numerical value of a speed serving as the speed control value.

(15)

The information processing system according to any one of (1) to (14), wherein the information processing device includes a conversion unit that converts the input value into the speed control value, and wherein the input value and the speed control value have a relation of a straight line or a curved shape.

(16)

The information processing system according to any one of (1) to (15), wherein the information processing device is provided in the moving object.

(17)

The information processing system according to any one of (1) to (15), wherein the information processing device is provided in the input device.

(18)

An information processing method including controlling a speed of a moving object that autonomously moves along a preset trajectory based on an input value input from the user to an input device including an input unit that receives the input from the user.

(19)

An information processing program causing a computer to perform an information processing method of controlling a speed of a moving object that autonomously moves along a preset trajectory based on an input value input from the user to an input device including an input unit that receives the input from the user.

### REFERENCE SIGNS LIST

100 Moving object
200 Input device
204A Input unit
WH Wheel
LV Lever
300 Information processing device
1000 Information processing system

1. An information processing system comprising:
an information processing device configured to control a speed of a moving object that autonomously moves along a preset trajectory; and
an input device including an input unit that receives an input from a user and is configured to supply an input value input by the user and used to control the speed of the moving object to the information processing device.

2. The information processing system according to claim 1,
wherein the moving object autonomously moves to pass through an arbitrary target position preset on the trajectory at a preset target time or target speed, and wherein the information processing device controls a speed by updating the target position and/or the target speed based on a speed control value obtained from the input value.

3. The information processing system according to claim 2, wherein the speed of the moving object is controlled based on a difference between the updated target speed and a present speed of the moving object.

4. The information processing system according to claim 2, wherein the speed of the moving object is controlled based on a difference between the updated target position and a present position of the moving object.

5. The information processing system according to claim 1, wherein the input unit is configured by a uniaxial operator.

6. The information processing system according to claim 5, wherein the input unit is configured by a wheel and/or a lever.

7. The information processing system according to claim 1, wherein the input unit is configured by a touch panel that has an input region of the input value.

8. The information processing system according to claim 7, wherein the input region of the input value is configured in a slider shape with which continuous values are able to be input.

9. The information processing system according to claim 7, wherein the input region of the input value is configured in a button shape with which discrete values are able to be input.

10. The information processing system according to claim 1, wherein a range is provided for the input value for performing control such that the speed of the moving object becomes a predetermined speed.

11. The information processing system according to claim 1, wherein the input device includes a notification unit that notifies the user that the input from the user is within and/or outside of the range of the input value.

12. The information processing system according to claim 1, wherein the input unit includes a notification unit that notifies the user that the input from the user is the input value that causes the speed of the moving object to be a predetermined speed.

13. The information processing system according to claim 1, wherein the speed is controlled based on a magnifying power of a speed serving as the speed control value.

14. The information processing system according to claim 1, wherein the speed is controlled based on a numerical value of a speed serving as the speed control value.

15. The information processing system according to claim 1,
wherein the information processing device includes a conversion unit that converts the input value into the speed control value, and
wherein the input value and the speed control value have a relation of a straight line or a curved shape.

16. The information processing system according to claim 1, wherein the information processing device is provided in the moving object.

17. The information processing system according to claim 1, wherein the information processing device is provided in the input device.

18. An information processing method comprising:
controlling a speed of a moving object that autonomously moves along a preset trajectory based on an input value input by a user to an input device including an input unit that receives the input from the user.

19. An information processing program causing a computer to perform an information processing method of controlling a speed of a moving object that autonomously moves along a preset trajectory based on an input value input by a user to an input device including an input unit that receives the input from the user.
